(19) United States
(12) Patent Application Publication
(10) Pub. No.: US 2005/0209117 A1
(43) Pub. Date: Sep. 22, 2005

(54) Complexing agent for treating metallic and plastic surfaces

(75) Inventors: Ralf Friedrich, Wiesloch (DE); Werner Hesse, Obrigheim (DE); Hans-Ulrich Jager, Neustadt (DE); Helmut Witteler, Wachenheim (DE)

Correspondence Address: NIXON & VANDERHYE, PC, 901 NORTH GLEBE ROAD, 11TH FLOOR, ARLINGTON, VA, 22203, US

(73) Assignee: BASF Aktiengesellschaft, Ludwigshafen (DE)

(21) Appl. No.: 10/518,447

(22) PCT Filed: Jun. 18, 2003
(86) PCT No.: PCT/EP03/06491

§ 371 Date: Jun. 1, 2005

(30) Foreign Application Priority Data
Jun. 19, 2002 (DE) 102 27 362.6

(51) Int. Cl. C11D 1/00

(52) U.S. Cl. 510/175

(57) ABSTRACT

A composition for the surface treatment of metals and for the deposition of metals or metal alloys and plastics surfaces comprises
a) at least one polymer as component A, comprising at least one structural unit of the formula (I) 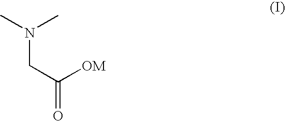 where this structural unit may be part of a polymer main chain or may be bound to a polymer main chain via an anchor group, and M is hydrogen or an ammonium or metal cation; b) water or another solvent which is suitable for dissolving, dispersing, suspending or emulsifying the polymer (component A), as component B; c) if required, surface-active compounds, dispersants, suspending media and/or emulsifiers as component C; either d) if required, a salt, an acid or a base based on transition metal cations, transition metal oxoanions, fluorometallates or lanthanoids as component D, and/or e) at least one acid selected from the group consisting of phosphoric acid, sulfuric acid, sulfonic acid, nitric acid, hydrofluoric acid and hydrochloric acid as component E, or a base and/or f) at least one metal oxide and/or metal salt as component F. Furthermore, in a process for the surface treatment of metals and in a process for the deposition of metals or metal alloys on a metal surface or plastics surface, the metal surface or plastics surface is brought into contact with a polymer (component A). Moreover, polymers (component A) are used for the surface treatment of metals and for the deposition of metals or metal alloys on a metal surface or plastics surface.

The present invention relates to compositions for the surface treatment of metals, processes for the surface treatment of metals and the use of polymers for the surface treatment of metals. The present invention furthermore relates to a composition and process and the use of polymers for the deposition of metals or metal alloys on metal and plastics surfaces.

In chemical and electrochemical metal deposition on metal or plastics and in the surface treatment of metals, formulations which contain complexing agents for metal cations are used.

Thus, U.S. Pat. No. 6,284,309 relates to a process for the production of a surface which is suitable for forming a cocontinuous bond. The process comprises the following steps:
a) production of a substrate from copper or a copper alloy,
b) use of an etching composition which comprises the following components:
   ba) an acid
   bb) an oxidizing agent,
   bc) a complexing agent for copper which is selected from the group consisting of thioureas and imidazolethiones, and
   bd) a copper complex in an amount in which it is precipitated when applied to the substrate comprising copper or copper alloy.

The amount of complexing agent in the etching composition is from 0.5 to 20% by weight.

U.S. Pat. No. 6,197,181 relates to a process for applying a metallic contact to a semiconductor surface. The process comprises the formation of an ultrathin metal seed layer on a barrier layer applied to the semiconductor surface. This ultrathin layer can then be thickened by depositing further metal on it. Copper is preferably used as a further metal. Particularly preferably, the deposition is carried out electrochemically in an alkaline bath. Complexing agents selected from the group consisting of EDTA (ethylenediaminetetraacetic acid), ED (ethylenediamine) and polycarboxylic acids, in particular citric acid, or salts thereof are used as complexing agents in this bath.

The complexing agents used in the prior art in formulations for metal deposition or for the surface treatment of metals have the disadvantage that they give rise to ecological problems during their disposal. Complexing agents which enter the wastewater are problematic since they make heavy metals bioavailable.

It is an object of the present invention to provide complexing agents for formulations for the deposition of metals on metal or plastics surfaces and for formulations for the surface treatment of metals, which formulations are ecologically safe.

We have found that this object is achieved by a composition for the treatment of metal or plastics surfaces, comprising
a) at least one polymer as component A, comprising at least one structural unit of the formula (I) 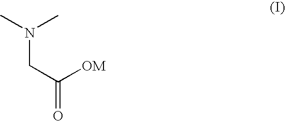
   where this structural unit may be part of a polymer main chain or may be bound to a polymer main chain via an anchor group, and
   M is hydrogen or an ammonium or metal cation;
b) water or another solvent which is suitable for dissolving, dispersing, suspending or emulsifying the polymer (component A), as component B;
c) if required, surface-active compounds, dispersants, suspending media and/or emulsifiers as component C;
   either
d) if required, a salt, an acid or a base based on transition metal cations, transition metal oxoanions, fluorometallates or lanthanoids as component D, and/or
e) at least one acid selected from the group consisting of phosphoric acid, sulfuric acid, sulfonic acid, nitric acid, hydrofluoric acid and hydrochloric acid as component E, or a base selected from the group consisting of alkali metal and alkaline earth metal hydroxides and ammonia solution or
f) at least one metal oxide and/or metal salt as component F.

Polymer main chain is to be understood as meaning the longest chain forming the polymer. This chain is composed of carbon atoms connected in series by covalent bonds, although this carbon chain can be interrupted by hetero atoms, in particular nitrogen, silicon or oxygen. Furthermore, this chain may have branches which are likewise composed of carbon atoms and, if required, nitrogen and oxygen atoms.

An anchor group is to be understood as meaning a group which links the structural unit of the formula (I) to the polymer main chain. Such anchor groups may be alkylene groups of 1 to 14 carbon atoms which may be interrupted by hetero atoms, in particular nitrogen or oxygen. These anchor groups can be bonded to carbon atoms or to hetero atoms in the polymer main chain.

The polymers (component A) used according to the invention are very useful as complexing agents in the compositions for the treatment of metal surfaces and also in compositions for the deposition of metals on metal or plastics surfaces. In a natural environment, for example in wastewater treatment plants, the polymers are precipitated quantitatively or are absorbed on the surface. This process is also referred to as bioelimination and is considered to be ecologically advantageous by a person skilled in the art.

Surprisingly, it has furthermore been found that the polymers (component A) used according to the invention increase the stability of the compositions, in particular of baths for chemical metal deposition.

The novel composition can be used in all processes for metal treatment or for the deposition of metals on plastics surfaces.

Compositions comprising the components A, B, if required C and D and/or (instead of D) E are particularly suitable for the surface treatment of metals, while compositions comprising components A, B, if required C and F, are particularly suitable for the deposition of metals or metal alloys on metal or plastics surfaces.

Such processes are, for example, the passivation, in particular phosphation, preferably chromate-free phosphation, of metal surfaces, the pickling of metal surfaces, the sealing of metal surfaces and metal deposition on metal surfaces, for example by nickel-plating, zinc-plating, tin-plating, copper-plating or deposition of alloys. Furthermore, the compositions can be used for the production of finishes or rust converters. Moreover, the novel compositions can be used for the deposition of metals on plastics surfaces, for example in the production of circuit boards.

Suitable metal surfaces are in general industrially conventional materials selected from the group consisting of aluminum alloys, magnesium alloys, steel, copper, zinc, tin, nickel, chromium and industrially conventional alloys of these metals. Further suitable metal surfaces are noble metals, in particular gold and silver and their alloys. Furthermore suitable are in general industrially conventional metal coatings which can be produced chemically or electrochemically, selected from the group consisting of zinc and the alloys thereof, preferably metallic zinc, zinc/iron, zinc/nickel, zinc/manganese or zinc/cobalt alloys, tin and the alloys thereof, preferably metallic tin, alloys of tin which contain Cu, Sb, Pb, Ag, Bi and Zn, particularly preferably those which are used as solders, for example in the production and processing of circuit boards, and copper, preferably in the form in which it is used on circuit boards and metallized plastics parts.

If the novel compositions are used for pickling or passivation, in particular phosphation, of metal surfaces, metal surfaces comprising steel, cast iron, zinc, aluminum, magnesium and/or alloys of these metals with one another or with other alloy components are preferred. Zinc and aluminum and alloys of these metals with other alloy components are particularly preferred in these cases.

If the novel compositions are used for the deposition of metals on metal surfaces, steel surfaces are preferred in the case of zinc-plating and deposition of zinc alloys and in the case of copper-plating and nickel-plating, and copper and steel in the case of tin-plating (including tin alloys).

It is conceivable to use the novel composition for the treatment of metal surfaces which have not been pretreated. However, it is preferable for the metal surfaces to at least have been cleaned before a treatment with the novel composition. The cleaning preferably comprises, inter alia, degreasing of the metal surface. Suitable cleaning or degreasing methods are known to a person skilled in the art. It is also possible to use the novel composition in a process step after pickling or passivation of the material surface, for example in a coating step. The novel compositions can also be used as cleaning, pickling and polishing formulations which may contain additives known to a person skilled in the art and may be used in corresponding processes.

The novel compositions can furthermore be used for the deposition of metals or metal alloys on plastics surfaces. Compositions which are suitable for the nickel-plating and copper-plating of plastics surfaces, for example for copper-plating in the production of circuit boards, are preferred. The plastics surfaces are prepared by technically conventional metallization methods. The novel compositions serve for the metallization of the plastic but, if required, may also be used in the pretreatment for the metallization.

In the context of the present application, compositions are to be understood as meaning both the ready-to-use compositions and concentrates. The concentrations stated below for the individual components relate to the ready-to-use compositions. However, it is known to a person skilled in the art that the concentrations of the individual components in concentrates are correspondingly higher.

Component A

The component A is a polymer comprising at least one structural unit of the formula (I) 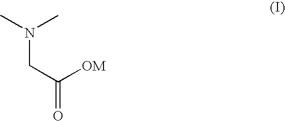
where this structure unit may be a part of a polymer main chain or may be bound to a polymer main chain via an anchor group, and
M is hydrogen or an ammonium or metal cation.

In general, M is an alkali metal cation, preferably a sodium or potassium ion. However, it is also conceivable for M to be a divalent or polyvalent cation, preferably an alkaline earth metal cation or Zn, Mn or Cr(III), particularly preferably magnesium or calcium.

The weight average molecular weight of the polymers used as component A is in general >500, preferably >1000, particularly preferably 1000-100 000, g/mol. The weight average was determined by means of light scattering.

Particularly preferably, the component A is a polymer which comprises one or more repeating units of the formulae (II), (III) and/or (IV), and/or one or two terminal groups of the formula (V) and, if required, further units of the formula (VI).

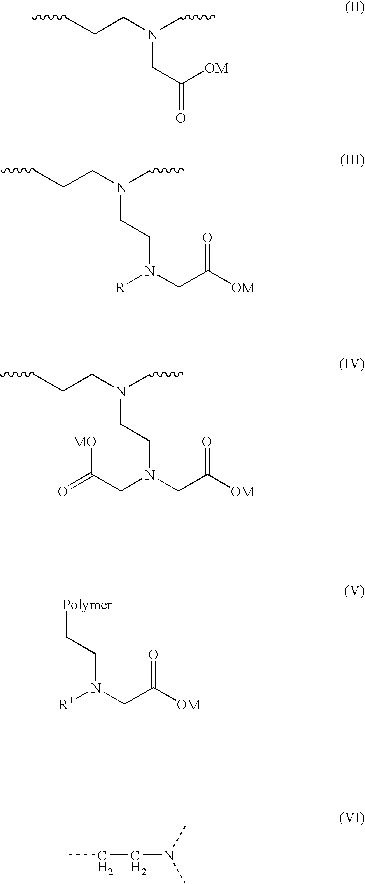

Therein,
R is or any desired substituted or unsubstituted organic radical, preferably H or a radical based on ethyleneimine, such as —(CH₂CH₂NH)ₙ—H
R* is hydrogen or —CH₂—CO₂M
M is hydrogen or an ammonium or metal cation, suitable metal cations being in general alkali metal cations, preferably sodium or potassium ions, or Ag or divalent or polyvalent cations, preferably alkaline earth metal cations or Zn, Mn or Cr(III), Ni, Fe Co, Cu, Au, Pd, Sn, Pb, Bi,
n is the number of repeating units depending on the weight average molecular weight of the polymer and
   Polymer is any desired polymer which is suitable for binding the structural unit defined in formula (V).

The polymers used according to the invention are in general water-soluble.

Very particularly preferably, the component A comprises water-soluble, carboxylated, amino-containing polymers. These may be obtained by reacting water-soluble, amino-containing polymers with at least one aldehyde and/or alkali metal cyanide or a cyanohydrin obtained from an aldehyde and an alkali metal cyanide in aqueous solution. Suitable water-soluble amino-containing polymers are all water-soluble compounds which contain a basic NH group. Compounds of this type are, for example, polyalkylene-polyamides. Examples of these are polyalkylenepolyamines which have at least four basic nitrogen atoms, such as tetraethylenepentamine, pentaethylenehexamine, hexaethyleneheptamine and polyethylenediamines.

Among the polyalkylenepolyamines, polyethyleneimines are preferred. These particularly preferably have molar masses of from 200 to 10 000 000, very particularly preferably from 1 000 to 3000 000 (weight average molecular weight). Polyethyleneimines having molar masses of from 2 000 to 1 300 000 are particularly preferably used.

Chemically modified polyethyleneimines, too, can be subjected to carboxyalkylation. Such modified polyethyleneimines are, for example, alkylated polyethyleneimines. They are known and are prepared, for example, by reacting polyethyleneimines with alkylating agents, such as alkyl halides (cf. U.S. Pat. No. 3,251,778 and EP-B 0 379 161). A further alkylating agent is, for example, dimethyl sulfate. The degree of alkylation of the polyethyleneimines is in general up to 50%, preferably from 1 to 10%. Degree of alkylation is understood as meaning the percentage of the alkylated monomer units in the polymer, based on the total number of monomer units in the polyethyleneimine. Suitable alkyl halides are, for example, C₁₋₃₀-alkyl halides.

Further suitable modified polyethyleneimines are reaction products of polyethyleneimines with C₂₋₂₂-epoxides. These reaction products are usually prepared by alkoxylating polyethyleneimines in the presence of bases as a catalyst.

Furthermore, sulfonated and phosphonomethylated polyethyleneimines are suitable. They can be prepared from the polyethyleneimines by sulfonation or phosphonomethylation.

The carboxyalkylation is effected in general by reacting the water-soluble amino-containing polymers with an aldehyde, preferably formaldehyde, and an alkali metal cyanide, preferably sodium cyanide. However, it is also possible to use a cyanohydrin obtained from an aldehyde and an alkali metal cyanide, for example glycol nitrite, which is formed by an addition reaction of sodium cyanide with formaldehyde.

Carboxymethylated polyethyleneimines are preferably used as component A. These are preferably obtained by carboxymethylation of polyethyleneimines with formaldehyde and sodium cyanide.

The carboxyalkylation of water-soluble, amino-containing compounds is preferably continued until from 1 to 100% of the NH groups in amino-containing polymers are carboxyalkylated. The aldehyde and the alkali metal cyanide are particularly preferably used in an amount such that from 75 to 100% of the NH groups in the amino-containing polymers are carboxyalkylated. The degree of the carboxymethylation preferably carried out is usually from 80 to 100%, based on the NH groups in the polymer.

Processes for the preparation of the water-soluble amino-containing polymers preferably used as component A, particularly preferably for the preparation of carboxyalkylated polyethyleneimines, very particularly preferably for the preparation of carboxymethylated polyethyleneimines, are disclosed in WO 97/40087.

The polymers used according to the invention as component A are employed in a concentration of c(A)/c(M) of from >0.001 to <1 000, preferably from >0.01 to <100, particularly preferably from >0.1 to <10.

Here,
c(A) is the number of carboxylated groups (or carboxyl groups) contained in the polymer in the novel composition;
c(M) is the number of metal cations in a novel composition for the deposition of metals on metal or plastics surfaces or the number of metal cations which are brought into solution during use of compositions for the treatment of metal surfaces by the surface treatment of the metal M.

It is therefore important for the complexing agent used in the novel compositions to be suitable for complexing metal cations in high concentrations. The type of metal cations is dependent on which metals are to be deposited on metal or plastics surfaces or which metals are to be subjected to a surface treatment with the novel compositions. Preferably, metal cations of Zn, Ni, Cu, Au, Pd, Sn, Co, Mn, Fe, Mg, Pb, Bi, Au and Ag or mixtures of these metal cations (for the deposition of alloys) are complexed.

Component B

The component B is water or another solvent which is suitable for dissolving or for dispersing, suspending or emulsifying the polymer (component A). Other suitable solvents apart from water are, for example, aliphatic or aromatic solvents, such as benzene, toluene and xylene, halogenated solvents, such as methylene chloride and chloroform, alcohols, such as methanol and ethanol, ethers, such as diethyl ether and tetrahydrofuran, polyethers, in particular polyethylene glycol, ketones, such as acetone, and mixtures of these solvents with one another and/or with water. Particularly preferably, exclusively water is used as the solvent.

The pH is determined by the type of application. For example, pickling and phosphating baths are generally strongly acidic and electroplating baths are basic or acidic, depending on the type of bath. pH values suitable for the specific applications are known to a person skilled in the art.

The amount of water or another solvent is dependent on whether the novel composition is a ready-to-use composition or concentrate and on the respective intended use. In principle, the amount is determined by those concentrations of the individual components which are specified for the ready-to-use composition.

Component C

If required, the novel composition may additionally contain surface-active compounds, emulsifiers and/or dispersants. Suitable surface-active compounds are surfactants which to may be cationic, anionic, zwitterionic or nonionic. Suitable surfactants are, for example, alkyl and alkylene alkoxylates of the type R-EOn/POm, where R is in general a linear or branched C₆-C₃₀-alkyl radical, preferably C₈-C₂₀-alkyl radical, EO is an ethylene oxide unit and PO is a propylene oxide unit, it being possible for EO and PO to be arranged in any desired sequence, and n and in, independently of one another, are >1 and <100, preferably >3 and <50, e.g. Emulan®, Lutensol®and Plurafac® (from BASF), alkylphenol ethoxylates, EO/PO block copolymers (Pluronic®, from BASF), alkyl ether sulfates and alkylammonium salts, i.e. quats.

The amount of these components in the novel composition is in general 0.01-100, preferably from 0.1 to 20, g/l.

Component D

Salts, acids and bases based on transition metal cations, transition metal oxoanions, fluorometallates or lanthanoids are suitable as component D. Suitable transition metal cations are in particular fluorometallates of Ti (IV), Zr (IV), Hf (IV) and/or Si (IV), and suitable lanthanoids are in particular Ce. Furthermore, tungstates and molybdates are suitable.

Compositions according the present application, comprising the component D, are suitable in particular either for depositing a corrosion-inhibiting layer on a metal surface or for enhancing the corrosion-inhibiting effect of a corrosion layer already deposited on the metal surface.

If the component D is contained in the novel compositions, the amount of the component D is preferably from 0.02 to 20 g/l.

Component E

In addition to or instead of the component D, the novel compositions may furthermore contain at least one acid selected from the group consisting of phosphoric acid, sulfuric acid, sulfonic acids, such as methanesulfonic acid, vinylsulfonic acid, allylsulfonic acid, m-nitrobenzenesulfonic acid, naphthalenesulfonic acid and derivatives thereof, nitric acid, hydrofluoric acid and hydrochloric acid. Instead of an acid, E may also be a base selected from the group consisting of alkali metal and alkaline earth metal hydroxides and ammonia solution, in particular NaOH and KOH. The type of acid used is dependent on the type of treatment of the metal surface. Thus, phosphoric acid is generally used in phosphating baths for phosphating steel surfaces. In this case, the novel composition is a phosphating solution. A distinction is made here between non-layer-forming phosphating solutions, i.e. solutions which have no divalent metals. Such non-layer-forming phosphating solutions are present, for example, in the form of an iron phosphating solution. If phosphating solutions contain ions of divalent metals, e.g. zinc and/or manganese, the phosphating solutions are present in the form of layer-forming phosphating solutions. Nitric acid-containing compositions according to the present application are suitable in particular for the surface treatment of zinc and its alloys, while hydrofluoric acid-containing compositions are particularly suitable for the surface treatment of aluminum and its alloys.

The amount of acid or base used can be varied depending on the field of use. In general—if the component E is present in the novel compositions—from 0.2 to 200, preferably from 2 to 100, g/l of the component E are used.

Component F

Suitable metal oxides or metal salts are the oxides or salts of metals selected from the group consisting of Zn, Ni, Cu, Au, Pd, Sn, Co, Mn, Fe, Mg, Pb, Bi and Ag. The metals can be deposited in the form of the metal used or—with the use of different metals—in the form of alloys of said metals with one another or with other metals. Preferred alloys are CuZn, CuSn, CuNi, SnPb, SnAgBiCu, SnAgCu, SnBi, SnAg, SnCu, NiPd, NiP, ZnFe, ZnNi, ZnCo and ZnMn. Said components of the alloys may be present in any desired concentrations in the alloy. Particularly preferably, Zn, Cu and Ni and alloys of these metals with other metals or with one another are deposited. In the deposition of metals or metal alloys on plastics surfaces, Ni and Cu are particularly preferred. In addition to the use as metal oxide, the metals can be used in the form of metal salts selected from the corresponding sulfates, sulfonic acid salts, chlorides, carbonates, sulfamates, fluoroborates, cyanides and acetates.

The concentration of the metal ions in the novel compositions is in general from 0.01 to 100, preferably from 0.1 to 50, particularly preferably from 2 to 20, g/l, based on the amount of the metal used.

In a preferred embodiment, the novel composition is used for the surface treatment of metals and, in addition to the components A, B and, if required, C, and D and/or E, contains:
g) at least one corrosion inhibitor as component G,
   and/or
h) compounds of Ce, Ni, Co, V, Fe, Zn, Zr, Ca, Mn, Mo, W, Cr and/or Bi as component H,
   and/or
i) further assistants and additives as component I.

These compositions are particularly suitable for pickling or passivation, in particular phosphating, or as rust converters for the metal surfaces stated in the present application.

Component G

The novel compositions may contain at least one corrosion inhibitor. Suitable corrosion inhibitors are selected from the group consisting of butynediol, benzotriazole, aldehydes, amine carboxylates, amino- and nitrophenols, amino alcohols, aminobenzimidazole, aminoimidazolines, aminotriazole, benzimidazoleamines, benzothiazoles, derivatives of benzotriazole, boric esters with various alkanolamines, for example diethanolamine borate, carboxylic acids and their esters, quinoline derivatives, dibenzyl sulfoxide, dicarboxylic acids and their esters, diisobutenylsuccinic acid, dithiophosphonic acid, fatty amines and fatty amides, guanidine derivatives, urea and its derivatives, laurylpyridinium chloride, maleamides, mercaptobenzimidazole, N-2-ethylhexyl-3-aminosulfopropionic acid, phosphonium salts, phthalamides, amine- and sodium-neutralized phosphoric esters of alkyl alcohols and these phosphoric esters themselves, phosphoric esters of polyalkoxylates and here in particular of polyethylene glycol, polyetheramines, sulfonium salts, sulfonic acids, for example methanesulfonic acid, thioethers, thioureas, thiurarm disulfides, cinnamic acid and its derivatives, zinc phosphates, zinc silicates, zirconium phosphates and zirconium silicates.

Further corrosion inhibitors used are preferably butynediol and benzotriazole (in particular in the surface treatment of copper), and compounds structurally related to benzotriazole, such as tolyltriazole and benzotriazolecarboxylic acid.

Component G′

Other suitable corrosion inhibitors are polymers G′ composed of
ga) at least one amino-containing polymer as component G′a
gb) at least one aromatic compound as component G′b, which is a phenol or a quinone or has a phenolic or quinoid structural unit;
gc) if required, an aldehyde as component G′c.

The component G′ is a polymer composed of at least one amino-containing polymer as component G′a and at least one aromatic compound as component Gb, which is a phenol or quinone or has a phenolic or quinoid structural unit. If required, the polymer as component G′c contains a building block originating from a reaction of an aldehyde.

In general, polymers are to be understood as meaning those compounds which have at least three, preferably more than 10, repeating units. The weight average molecular weight of the polymers used according to the invention is in general from 500 to 5 000 000, preferably from 1 000 to 1 500 000, g/mol. The polymer may also be crosslinked so that it is not possible to state a molecular weight although the polymer can be dispersed, emulsified or suspended in industrially conventional solvents.

Component G′a

The component G′a is an amino-containing polymer. Preferably used polymers are polyethyleneimine, polyvinylamine, poly(vinylformamide-co-vinylamine), polylysine and polyaminostyrene. Furthermore, derivatives of polyamines which still have amino groups, for example the reaction products of polyamines with carboxylic acids or sulfonic acids or carboxymethylation products of polyamines, are suitable. Further suitable and particularly preferred polymers are amino-containing derivatives of polycarboxylates, in particular the reaction products of diamines and copolymers which contain maleic acid, acrylic acid or methacrylic acid repeating units, such as the reaction products of styrene/maleic anhydride copolymers with diamines. Very particularly preferred are polymers of the formulae (X) and (XI):

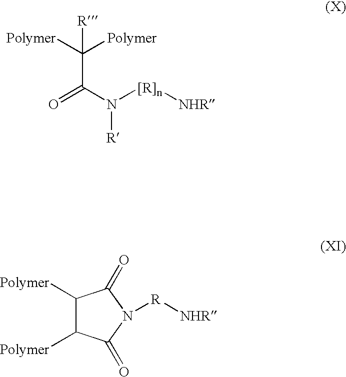

Therein, R is an organic radical, preferably an alkylene, cycloalkylene, arylene, arylalkylene or alkylarylene radical. This radical may be interrupted by hetero atoms or substituted as desired, suitable substituents being alkyl, alkenyl, aryl, alkylaryl or arylalkyl radicals, which in turn may be interrupted by hetero atoms or substituted by hetero atom-containing groups. R is preferably a C₂₋₃₂-alkylene radical, particularly preferably a C₂₋₁₄-alkylene radical, which may be interrupted by hetero atoms selected from —N— and —O— and may carry C₁₋₆-alkyl radicals or hetero atom-containing groups, e.g. amino groups. Particularly preferred radicals are ethyl, n-butyl and n-hexyl radicals.

R′, R″ and R′″, independently of one another, are hydrogen or any desired organic radicals. Suitable organic radicals are in general alkyl, cycloalkyl, alkenyl, aryl, alkylaryl and arylalkyl radicals which may be interrupted by hetero atoms or substituted by hetero atom-containing groups. R′, R″ and R′″, independently of one another, are preferably hydrogen or a hydrocarbon, particularly preferably hydrogen, C₁₋₆-alkyl or C₆₋₁₀-aryl, very particularly preferably methyl, ethyl, isopropyl, n-propyl or phenyl.

The amino-containing polymers are commercially available (polyethyleneimine, polyvinylamine) or can be prepared by methods known to a person skilled in the art Suitable processes for the preparation of polyvinylamine are disclosed, for example, in EP-A 216 387, DE-A 38 42 820, DE-A 195 266 26 and DE-A 195 159 43. The particularly preferably used polymers of the formulae (X) and (XI) can be prepared, for example, according to the process disclosed in U.S. Pat. No. 4,046,748.

It is also possible to use the polymer in a mixture with low molecular weight amines. Suitable low molecular weight amines are selected from the group consisting of ethylenediamine, H₂N(—C₂H₄NH)ₙ—H where n=24, H₂N(—CH₂)ₙ—H where n=1-18, preferably n=2, 3, 4, 6, 8, 10 or 12.

The amino-containing polymers are present in general in a form free from salt. In the case of copolymers which have vinylamine and vinylformamide repeating units, the degree of hydrolysis is in general from 0.5 to 100%, preferably from 50 to 100%.

Component G′b

The component G′b is a phenol or quinone or a compound which has a phenolic or quinoid structural unit.

Suitable quinones or quinone derivatives are in general systems derived from o-benzoquinone or from p-benzoquinone. Systems derived from p-benzoquinone are preferably used. Particularly preferred compounds are those of the formula (VII): 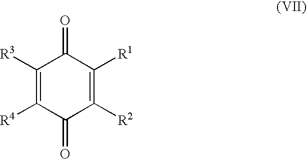
where R¹, R², R³ and R⁴, independently of one another, may be hydrogen or alkyl, alkenyl, cycloalkyl, aryl, alkylaryl or arylalkyl radicals. R¹ to R⁴, independently of one another, are preferably hydrogen or C₁- to C₁₄-alkyl, C₂ to C₁₄-alkenyl, C₆- to C₁₄-aryl or C₅- to C₁₆-cycloalkyl radicals. It is furthermore possible for R¹ and R² and/or R³ and R⁴, in each case together, to form a cyclic radical which may be saturated or unsaturated. This cyclic radical is preferably a cyclic structure comprising six carbon atoms altogether, two carbon atoms originating from the parent structure in formula (VII). Said radicals may in turn be substituted by alkyl, alkenyl, cycloalkyl, aryl, arylalkyl or alkylaryl radicals or may be interrupted by hetero atoms or substituted by hetero atom-containing groups. Particularly preferably, R¹ to R⁴ in formula (VII), independently of one another, are hydrogen or methyl. Particularly preferably used compounds of the formula (VII) are selected from the group consisting of benzoquinone, 2,3,5-trimethylbenzoquinone, 2,6-dimethylbenzoquinone, naphthoquinone and anthraquinone.

Suitable phenols or compounds which have a phenolic or quinoid structural unit are compounds of the formula (VIII):

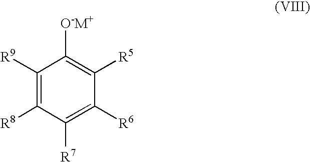

Therein, R⁵, R⁶, R⁷, R⁸ and R⁹, independently of one another, have the meanings stated for R¹ to R⁴. Furthermore, R⁵ and R⁶, or R⁷ and R⁷, or R⁷ and R⁸, or R⁸ and R⁹, together form a cyclic radical as defined for R¹ and R² or R³ and R⁴ Furthermore, one or two of the radicals R⁵ to R⁹ may be —O⁻M⁺.

M⁺ in formula (VIII) is hydrogen or a cation. In general, M⁺ is an alkali metal cation, preferably a sodium or potassium ion. However, it is also conceivable for M⁺ to be a divalent or polyvalent cation, preferably an alkaline earth metal cation or Zn, Mn or Cr(III), particularly preferably magnesium or calcium.

In addition to said radicals, R⁵ to R⁹ may furthermore be —SO₃M⁺, —NO₂, halogen —COO⁻M⁺, —C(O)R″″ (where R″″ is hydrogen or an alkyl, aryl, cycloalkyl, aralkyl or alkaryl radical), —N(R″″)₂, —OR″″ —SH or other functional groups which are known to a person skilled in the art. In general, only one of the radicals R⁵ to R⁹ has one of the last-mentioned meanings.

Preferred compounds of the formula (VIII) are monohydric, dihydric or trihydric phenols which may be substituted by the above mentioned radicals. In addition to said phenolic compounds, their salts are also suitable.

Particularly preferred compounds of the formula (VIII) are phenol, 4,4′-dihydroxydiphenyl sulfide, dihydroxydiphenyl sulfoxide, phenolsulfonic acid, 1,4-dihydroxynaphthalene, nitrophenol, (N,N-dimethylamino)-1-phenol, hydroxythioanisole, pyrogallol, phloroglucinol, 1,2,4-trihydroxybenzene, 2,2′,4,4′-tetrahydroxybenzophenone, salicylic acid, 2,3-dihydroxybenzoic acid, 2,4-dihydroxybenzoic acid, 2,5-dihydroxybenzoic acid, trihydroxybenzoic acids, for example gallic acid, alkyl salicylates, for example ethyl salicylate, alkyl 3,4-dihydroxybenzoates, for example ethyl 3,4-dihydroxybenzoate, alkyl gallates, for example propyl gallate, 2,3-dihydroxybenzaldehyde, 2,4-dihydroxybenzaldehyde, 2,5-dihydroxybenzaldehyde, 2,3,4-trihydroxybenzaldehyde, (4-tert-butyl-2,6-dimethyl-3-hydroxy)benzyl)imidazoline, (s)-2-(3,4-dihydroxybenzyl)-2-hydrazinopropionic acid, 1,2-dihydroxy-4-tert-butylbenzene, 2-(4-hydroxyphenoxy)propionic acid, 2-(4-hydroxyphenyl)ethylamine, 2-(4-hydroxyphenyl)ethylamine, 2,3,5-trimethylbenzene-1,4-diol, 2,3-dihydro-1,4-dihydroxyanthraquinone, 2,4-dichlorophenol, 2,5-dihydroxytoluene, 2,5-dimethylphenol, 2,5-di-tert-pentylhydroquinone, 2,7-dihydroxynaphthalene, 2-allylphenol, 2-amino-4,6-dinitrophenol, 2-hydroxy-3-methylbenzoic acid, 2-hydroxyacetophenone, 2-hydroxyanthraquinone, 2-hydroxybenzaldehyde, methyl 2-hydroxybenzoate, 2-hydroxyphenylacetic acid, 2-hydroxyphenyl methylcarbamate, 2-naphthol-3,6-disulfonic acid, 2-tert-butyl-4-methylphenol, 2-tert-butylhydroquinone, 3,5-di-tert-butyl-4-hydroxytoluene, 3-aminophenol, 3-carboxy-2-hydroxynaphthalene, 3-methylphenol, 3-tert-butyl-4-hydroxyanisole, 4-(2-((3-4-(hydroxyphenyl-1-methylpropyl)amino)ethyl) 1,2-dihydroxybenzene, 4,4′-dihydroxybiphenyl, 4-acetylamino-1-hydroxybenzene, 4-chlorophenol, 4-diazo-3-hydroxynaphthalene-1-sulfonic acid, 4-hydroxyacetophenone, 4-hydroxybenzoic acid, propyl 4-hydroxybenzoate, 4-hydroxybenzophenone, 4-hydroxymandelic acid, 4-methoxyphenol, 4-methylphenol, 4-nitro-2-aminophenol-6-sulfonic acid, 5-chloro-2-hydroxytoluene, 5-nitro-2-aminophenol, 6-acetylamino-2-amino-1-hydroxybenzene-4-sulfonic acid, 6-hydroxynaphthalene-2-sulfonic acid, 8-hydroxy-2-methylquinoline, 8-hydroxyquinoline, adrenaline, alpha-tocopherol, amylmetacresol, bis(4-hydroxyphenyl) sulfone, bisphenol A, pyrocatechol, dopamine, estradiol, hydroquinone, isatinbiscresol, N,N-bis(hydroxyethyl)-4-hydroxyaniline, N,N-diethyl-m-aminophenol, N,N-dimethyl-2-(4-hydroxyphenyl)ethylamine sulfate, N,N-dimethyl-4-hydroxyphenylethylamine, N,N′-disalicylylethylenediamine, octadecyl 3-(3,5-di-tert-butyl-4-hydroxyphenyl)propionate, octylphenol, p-dodecylphenol and p-isononylphenol. In addition to the abovementioned phenolic compounds, their salts are also suitable.

Phenol and pyrocatechol are particularly preferably used.

Component G′c

The polymer (component G′) may be composed of an aldehyde as a further component, component G′c. This further component is present, for example, when the polymer is prepared by Mannich reaction. In general, all aldehydes are suitable as component G′c. Preferably used aldehydes are those of the formula (IX).

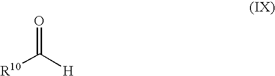

Therein, R¹⁰ is hydrogen, alkyl, alkenyl, cycloalkyl, aryl, aralkyl or alkaryl. It is possible for R¹⁰ to be substituted by hetero atoms or hetero atom-carrying groups. Furthermore, it is possible for the radicals mentioned for R¹⁰ to be interrupted by hetero atoms. R¹⁰ is preferably hydrogen, C₁₋₁₄-alkyl, C₁₋₁₄-alkenyl, C₅₋₁₆-cykloalkyl, C₆₋₁₄-aryl, C₇₋₄-aralkyl or C₇₋₁₈-alkaryl. These may be substituted by hetero atom-containing radicals selected from the group consisting of halogen, preferably chlorine or bromine, NO₂, SH, OH, acetyl, carboxyl or (—C(O)-phenyl) or interrupted by hetero atoms. R¹⁰ in turn may itself be substituted by alkyl, cycloalkyl, aryl, alkaryl or aralkyl radicals, which in turn may carry hetero atom-containing groups or whose chain or cyclic structure may be interrupted by hetero atoms.

Component G′c is particularly preferably at least one component selected from the group consisting of formaldehyde, ethanal, propanal, butanal, citronellal, benzaldehyde, 2-chlorobenzaldehyde, 2-hydroxybenzaldehyde, 2-propenal, 3,3-dimethylacrolein, 4-methylbenzaldehyde, 4-(1,1-dimethylethyl)benzaldehyde, anisaldehyde, 4-chlorobenzaldehyde, 3-hydroxy-2,2-dimethylpropanal, 7-hydroxy-3,7-dimethyloctanal, n-hexanal, 2-furfural, methyl 3-methyl-4-oxo-2-butenoate, 3-methylbutanal, 2-ethylhexanal, 2-methylpropanal, 2-phenylpropionaldehyde, 3,7-dimethylocta-2,6-dien-1-al, 4-(1,1-dimethylethyl)-alpha-methylbenzpropanal, pentanal, 2-methylpentanal, 2-methyl-2-pentenal, 3-acetyloxy-2-methylpropanal, 4-acetoxy-2-methyl-2-butenal, 3-formylpinane, 4-benzyloxybenzaldehyde, 2-methyl-4,4-diacetoxy-2-butenal, 2-methyl-2-propenal, terephthalaldehyde, 3-(4-methylphenyl)-2-methyl-2-propenal, 4-formylbenzoic acid, 3-nitrobenzaldehyde, 3-formyl-4-methyltetrahydropyran, 2-methyl-3-methylthiopropanal, methyl 2-formyl-2-methylpropionate, O-phthalaldehyde, retinal, 3-(4-methoxyphenyl)-2-methyl-2-propenal, 2,3-diphenylpropenal, methyl 3-formyl-2-methylpropionate and cinnamaldehyde.

The polymers (component G′) can be prepared by methods known to a person skilled in the art. Polymers which are obtained by Michael reaction (R1) and those which are obtained by incorporation of a suitable aldehyde (component 1c) analogously to a Mannich reaction (R2) are preferred. A Michael reaction (R1) is shown below for benzoquinone as an example:

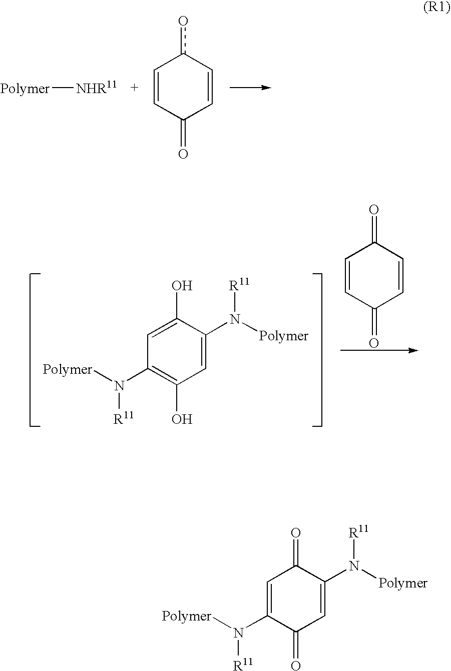

Therein, R¹¹ is hydrogen or an organic radical depending on the amino-containing polymer (component Ia) used. R¹¹ is preferably hydrogen or methyl.

The Mannich reaction (R2) likewise preferably used for the preparation of the polymers (G′) is shown below for phenol as an example:

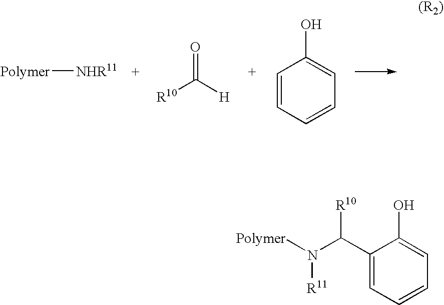

The meanings of R¹⁰ and R¹¹ have been stated above.

These polymers are disclosed in the prior, non-prior-published German Patent Application with the application number 101 64 609.7.

Instead of the component G′, the novel compositions may contain a corrosion inhibitor G″):

Component G″

The component G″ is at least one polymer composed of the structural element (1) 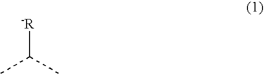
and at least three structural elements selected from the group consisting of 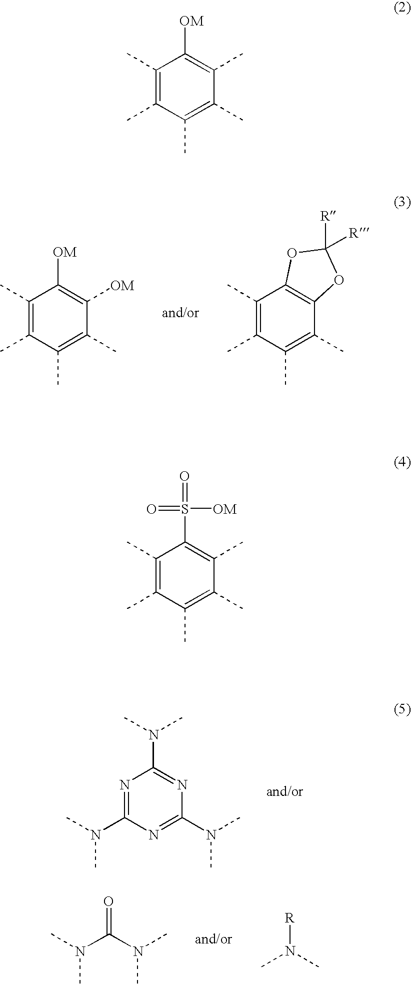
where
in structural element (1)
R′ is hydrogen or an alky, cycloalkyl, aryl, aralkyl or alkaryl radical of less than 31 carbon atoms which may be substituted by alkyl radicals or hetero atom-containing groups, preferably chloro, hydroxyl or amino groups, or may be interrupted by hetero atoms, preferably nitrogen or oxygen, or may contain double bonds; R′ is preferably hydrogen or C₁₋₆-alkyl, C₁₋₆-hydroxyalkyl, C₁₋₆-aminoalkyl or C₆₋₁₀-aryl,
   in structural element (3)
R″ and R′″ are any desired radical having a molecular weight of <200 g/mol, preferably independently of one another hydrogen or alkyl, cycloalkyl, aryl, aralkyl or alkaryl radicals, particularly preferably hydrogen or C₁₋₆-alkyl or C₆₋₁₀-aryl radicals, in structural elements (2), (3) and (4)
M, in each case independently of one another, are hydrogen or a cation, preferably an alkali metal cation, particularly preferably a sodium or potassium ion, or a divalent or polyvalent cation, preferably an alkaline earth metal cation or Zn, Zr, Cr, Mn, Fe, Co, Ni, Cu, Al, Ce or V, particularly preferably magnesium, calcium, zinc or manganese, if sufficient compensating negative charges are present,
   and
   in structural element (5)
R is hydrogen or an alkyl, cycloalkyl, aryl, aralkyl or alkaryl radical which may be substituted by alkyl radicals or hetero atom-containing groups, preferably chloro, hydroxyl or amino groups, or may be interrupted by hetero atoms, preferably nitrogen or oxygen; R is preferably hydrogen or C₁₋₆-alkyl, C₁₋₆-hydroxyalkyl, C₁₋₆-aminoalkyl or C₆₋₁₀-aryl.

The weight average molecular weight of the polymers used is in general >500, preferably from 1 000 to 1 500 000, g/mol.

The polymers (component G″) preferably have the following elemental composition:
C: 20-82, preferably from 30 to 80, particularly preferably from 40 to 70, % by weight,
H: 2.3-12.5, preferably from 2.3 to 8, particularly preferably from 2.5 to 5.5, % by weight,
N: 1-61, preferably from 1 to 20, particularly preferably from 1 to 15, % by weight,
O: 2-50, preferably from 5 to 50, particularly preferably from 20 to 45, % by weight,
S: 0-18.5, preferably from 0.5 to 18.5, particularly preferably from 5 to 15, % by weight,
X: 046, preferably from 0 to 38, particularly preferably from 1 to 13, % by weight,
   X being any desired chemical element, preferably one or more of the cations stated for M

The component G″ is prepared by any desired method. Suitable processes are known to a person skilled in the art. In a particularly preferred embodiment, the component G″ is prepared by polycondensation. Suitable process conditions for a polycondensation are known to a person skilled in the art from the preparation of phenol resins, urea resins and melamine resins, which is disclosed, for example, in ULLMANN'S ENCYCLOPEDIA OF INDUSTRIAL CHEMISTRY, SIXTH EDITION, 2000 ELECTRONIC RELEASE, Section on “Phenolic Resins”, paragraphs 3 and 4, and in U.S. Pat. No. 4,252,938 and U.S. Pat. No. 4,677,159.

For the preparation of the polymers (component G″) by polycondensation, in general the following components are reacted with one another:
a) at least one aldehyde as component G″a,
b) at least one aromatic compound which carries at least one OM group or one sulfo group, —SO₂OM, or both groups, as component G″b,
c) if required, at least one compound selected from diphenols or polyphenols having vicinal OM groups,
it being possible for the vicinal OH group to be protected in the form of acetal or ketal, as component G″c,
where, in components G″b and G″c, M, in each case independently of one another, are hydrogen or a cation, preferably an alkali metal cation, particularly preferably a sodium or potassium ion, or a divalent or polyvalent cation, preferably an alkaline earth metal cation or Zn, Zr, Cr, Mn, Fe, Co, Ni, Cu, Al, Ce or V, particularly preferably magnesium, calcium, zinc or manganese, if sufficient compensating negative charges are present,
d) if required, at least one amino compound of component G″d,
   at least one of the components G″c and G″d being reacted in the preparation of the polymer (component G″).

The polycondensation can be effected in the presence of a catalyst. Suitable catalysts are known to a person skilled in the art. A catalyst selected from the group consisting of acids, preferably mineral acids and oxalic acid, and bases, preferably alkali metal or alkaline earth metal hydroxides, and salts of weak acids and bases is suitable.

These polymers are disclosed in the prior, non-prior-published German Patent Application with the application number 101 63 892.2.

The corrosion inhibitors—if they are used at all in the compositions—are employed in an amount of in general from 0.01 to 50, preferably from 0.1 to 20, particularly preferably from 1 to 10, g/l.

Component H

In addition to or, if required, instead of said components, compounds of Ce, Ni, Co, V, Fe, Zn, Zr, Ca, Mn, Mo, W, Cr and/or Bi may furthermore be used. The novel compositions are preferably Cr(VI)-free. If said compounds (component H) are nevertheless used, compounds selected from Fe, Zn, Zr and Ca are preferably employed. The amount of the compounds in the novel compositions—if these compounds are present at all—is in general from 0.01 to 100, preferably from 0.1 to 50, particularly preferably from 1 to 20, g/l.

Component I

In addition to one or more of the components G and H mentioned, the novel compositions may contain further assistants and additives. Suitable assistants and additives are, inter alia, conductivity pigments or conductive fillers, e.g. iron phosphide, vanadium carbide, titanium nitride, carbon black, graphite, molybdenum disulfide or tin- or antimony-doped barium sulfate, iron phosphide being preferred. Such conductivity pigments or conductive fillers are added to the novel compositions for improving the weldability of the metal surfaces to be treated or for improving subsequent coating with electro-dip coating materials. Furthermore, silica suspensions may be used, particularly when the compositions are used for the treatment of aluminum-containing surfaces.

These assistants or additives are present in general in finely divided form, i.e. their mean particle diameters are in general from 0.005 to 5 μm, preferably from 0.05 to 2-5 μm The amount of the assistants and additives is in general from 0.1 to 50, preferably from 2 to 35, % by weight, based on the total mass of the novel compositions.

The novel compositions may furthermore contain additives for improving the forming behavior, for example wax-based derivatives based on natural or synthetic waxes, e.g. waxes based on acrylic acid, polyethylene waxes, polytetrafluoroethylene (PTFE) waxes or wax derivatives or paraffins and their oxidation products.

Depending on their field of use, the novel compositions may contain polymer dispersions based on styrene, 4-hydroxystyrene, butadiene, acrylic acid, acrylic esters, acrylamides, acrylates, methacrylic acid, methacrylic esters, methacrylamides, methacrylates and derivatives of acrylamide. It is furthermore possible for the novel compositions to contain polyurethane dispersions and polyesterurethane dispersions or polyurea dispersions.

A further group of compounds which may be present in the novel compositions comprises polyethylene glycols, polypropylene glycols, copolymers of ethylene oxide and copolymers of propylene oxide.

If the novel compositions are used in powder coating materials, they may additionally contain epoxy resins and/or condensation resins of formaldehyde with phenol, urea, melamine, phenolsulfonic acid or naphthalenesulfonic acid.

When the novel compositions are used in rust converters, they may additionally contain polyvinylbutyral.

Depending on the exact composition of the novel compositions comprising the component A, they may be used in all applications for the surface treatment of metals, in particular in those applications in which the corrosion of metal surfaces may present a problem. Such applications are, for example, stripping of surface coatings, metal pickling, electropolishing, chemical deburring, chemical and electrochemical metal deposition (in particular of Cu, Ni, Pd, Zn, Co, Mn, Fe, Mg, Sn, Pb, Bi, Ag, Au and their alloys), conversion coat formation (in particular no-rinse conversion coat formation, i.e. methods with a reduced number of rinse operations, for example on galvanized steel and aluminum), corrosion prevention (in particular on copper, for example in the production of circuit boards, and on steel), lubrication and greasing (in particular in cold forming). The method of application corresponds to the technically conventional methods, with the addition that the novel compositions are used together with further components industrially conventional for corresponding applications, or that they are brought into contact with the metal in additional treatment steps, for example spraying, dipping, coating or electro-coating, with the use of suitable formulations of the novel corrosion-inhibiting compositions, such as solutions, emulsions, dispersions, suspensions or aerosols.

The present application furthermore relates to compositions for metal deposition on metal or plastics surfaces, comprising, in addition to the components A, B and, if required, C, and F:
j) if required, at least one acid or one alkali metal salt or alkaline earth metal salt of the corresponding acid as component J, and
k) if required, further additives as component K.

The novel compositions are particularly suitable for the deposition of metals or metal alloys on metal or plastics surfaces. Suitable metal surfaces have been mentioned above. The deposition of metals or metal alloys on plastics surfaces is preferably effected in the production of circuit boards. The deposition is preferably effected in a chemical or electrochemical process.

Component J

The novel compositions can, if required, furthermore contain at least one acid or one alkali metal salt or alkaline earth metal salt of the corresponding acid, preferably selected from the group consisting of HNO₃, H₂SO₄, H₃PO₄, formic acid and acetic acid. The acid is generally used in an amount of from 0.5 to 700, preferably from 5 to 200, g/l.

Component K

In addition to said components, the novel compositions may contain further additives which may differ depending on the intended use, metal to be deposited, objective and process used. Suitable additives are 1-(2-vinylpyridinium)-2-ethylsulfobetaine, 1,1-dimethyl-2-propynyl-1-amine, 1-pyridinium-2-ethylsulfobetaine, 1-pyridinium-2-hydroxy-3-propylsulfobetaine, 1-pyridinium-3-propylsulfobetaine, 2,2′-dichlorodiethyl ether, 2,5-dimethyl-31-hexyne-2,5-diol, 2-butyne-1,4-diol, 2-butyne-1,4-diol ethoxylate, 2-butyne-1,4-diol propoxylate, 3-(2-benzothiazolylthio)-1-propanesulfonic acid sodium salt, 3,3′-dithiobis(1-propanesulfonic acid) sodium salt, 3[(aminoiminomethyl)thiol]-1-propanesulfonic acid, 3-[(dimethylamino)thioxomethyl]thio-1-propanesulfonic acid sodium salt, 3-[ethoxythioxomethyl]thio-1-propanesulfonic acid potassium salt, 3-chloro-2-hydroxy-1-propanesulfonic acid sodium salt, 3-hexyne-2,5-diol, 3-mercapto-1-propanesulfonic acid sodium salt, 4,4-dihydroxydiphenyl sulfone, 4-methoxybenzaldehyde, aldehydes, potassium salts of alkylphenyl polyethylene oxide sulfopropyl ether, potassium salts of alkylpolyethylene oxide sulfopropyl ether, for example the potassium salt of tridecyl/pentadecylpolyethylene oxide sulfopropyl ether, allylsulfonic acid sodium salt, amidosulfonic acid, amine- and sodium-neutralized phosphoric esters of alkyl alcohols, aminocarboxylates, amino- and nitrophenols, aminoalcohols, aminobenzimidazole, aminoimidazolines, aminotriazole, methyl benzalacetoacetate, benzalacetone, aminobenzimidazoles, benzothiazoles, benzotriazole and its derivatives, benzyl pyridine-3-carboxylate, bisphenol A, boric esters with various alkanolamines, for example the diethanolamine ester of boric acid, carboxylic acids and their esters, carboxyethylisothiuroniumbetaine, quinoline derivatives, copolymers of ethylene and acrylic acid, copolymers of imidazole and epichlorohydrin, copolymers of imidazole, morpholine and epichlorohydrin, copolymers of N,N′-bis[3-(dimethylamino)propyl]urea and 1,1′-oxybis[2-chloroethane], copolymers of n-butyl acrylate, acrylic acid and styrene, dibenzyl sulfoxide, dicarboxylic acids and their esters, diethylenetriaminepentaacetic acid and salts derived therefrom, diisobutenylsuccinic acid, disodium ethylenebisdithiocarbamate, dithiophosphonic acid, ethylamidosulfonic acid, ethylenediaminetetraacetic acid and salts derived therefrom, ethylglycinediacetic acid and salts derived therefrom, ethylhexanol ethoxylate, fatty amines and fatty amides, formaldehyde, glyceryl ethoxylate, guanidine derivatives, urea and its derivatives, hydroxyethyliminodiacetic acid and salts derived therefrom, imidazole, isopropylamidosulfonic acid, isopropylamidosulfonyl chloride, lauryl/myristyltrimethylammonium methosulfate, laurylpyridinium chloride, maleamides, mercaptobenzimidazole, methylamidosulfonic acid, N,N,N′,N′-tetrakis(2-hydroxypropyl)ethylenediamine, N,N-diethyl-2-propyn-1-ylamine, N,N-diethyl-4-amino-2-butyn-1-ol, N,N-dimethyl-2-propyn-1-ylamine, N-2-ethylhexyl-3-aminosulfopropionic acid, N-allylpyridinium chloride, the sodium salt of sulfated alkylphenol ethoxylates, sodium 2-ethylhexyl sulfate, nicotinic acid, nitrilotriacetic acid and salts derived therefrom, nitrobenzenesulfonic acid sodium salt, N-methallylpyridinium chloride, ortho-chlorobenzaldehyde, phosphonium salts, phthalamides, picolinic acid, polyetheramines, polyethyleneimines, polyvinylimidazole, propargyl alcohol, propargyl alcohol ethoxylate, propargyl alkyl propoxylate, propynesulfonic acid sodium salt, propiolic acid, propylenediaminetetraacetic acid and salts derived therefrom, pyrrole, quaternized polyvinylimidazole, the reaction product of 2-butyne-1,4-diol and epichlorohydrin, the reaction product of 2-butyne-1,4-diol and propane sultone, the reaction product of saccharin and propane sultone, the reaction product of alkyl ethoxylate/propoxylate with propane sultone, the reaction product of polyethyleneimine with propane sultone, the reaction product of β-naphthol ethoxylate/propoxylate with propane sultone, resorcinol ethoxylate, saccharin, β-naphthol ethoxylate, β-naphthol ethoxylate sulfate sodium salt, sulfonium salts, sulfonic acids, for example methanesulfonic acid, thiodiglycol, thiodiglycol ethoxylate, thioethers, thioureas, thiuram disulfides, vinylsulfonic acid sodium salt, cinnamic acid and its derivatives, zinc phosphates and zinc silicates, zirconium phosphates and zirconium silicates, hypophosphites (e.g. sodium hypophosphite), NaBH₄, dimethylaminoborane, diethylaminoborane, hydrazine, formaldehyde, uretropine, palladium chloride, sodium stannate, HF.BF₃, polyethylene glycols having a molecular weight of 100-1 000 000 g/mol, block copolymers of ethylene oxide and propylene oxide, for example Pluronic grades from BASF Aktiengesellschaft, Ludwigshafen/Rh., and random copolymers of ethylene oxide and propylene oxide, in particular having molecular weights in the range 100-2 000 g/mol.

In particular, metal depositions are possible by an electrochemical or chemical method with the aid of the novel compositions according to this embodiment. Whether an electrochemical or chemical deposition is carried out is dependent on the metal, on the metal surface and on the desired result.

Processes for the Treatment of a Metal Surface or Plastics Surface

The present application furthermore relates to a process for the surface treatment of metals, the metal surface being brought into contact with a polymer (component A), comprising at least one structural unit of the formula (I) 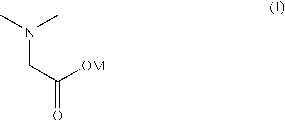
where this structural unit may be part of the polymer main chain or may be bound to the polymer main chain via an anchor group, and
M is hydrogen or an ammonium or metal cation.

This polymer and preferred embodiments of the polymer and suitable preparation processes have been mentioned above (cf. component A). Suitable metal surfaces and preferred embodiments of the metal surfaces have likewise been mentioned above.

Suitable processes are, for example, stripping of surface coatings, metal pickling, electropolishing, chemical deburning, chemical and electrochemical metal deposition, conversion coat formation (in particular no-rinse conversion coat formation), corrosion prevention (in particular on copper, for example in the production of circuit boards, and on steel), lubrication and greasing (in particular in cold forming).

The polymer may be present in solution, emulsion or suspension or in the form of an aerosol in the novel process. The polymer (component A) is preferably present in one of the abovementioned novel compositions.

The method of application corresponds to industrially conventional methods, with the addition that the polymers (component A) used according to the invention are used together with further components industrially conventional for the corresponding application, or that they are brought into contact with the metal in additional treatment steps, for example spraying, dipping, coating or electro-coating with the use of suitable formulations of the polymers.

In a preferred embodiment of the novel process, a metal surface is brought into contact with a composition which comprises the components A, B and, if required, C, and D and/or E, or with a composition which, in addition to the components A, B and, if required, C, and D and/or E, comprises components G and/or H and/or I as further components. Suitable components B to I have been mentioned above. In this preferred embodiment of the novel process, pickling or passivation, in particular phosphation of the metal surface, is preferably carried out. Suitable process steps and apparatuses for the passivation, in particular phosphation, or for the pickling of metal surfaces are known to a person skilled in the art.

In general, the treatment of the metal surfaces, in particular passivation, particularly preferably phosphation or pickling, is carried out by spraying a novel composition onto the metal surface or immersing the metal surface in a novel composition, depending on the number, size and shape of the parts to be treated.

If phosphation of metal strips is carried out, the novel compositions comprising phosphoric acid as component E can be applied by a roll-on or dry-in-place or no-rinse process, the novel phosphating composition being applied to the metal strip and being dried without washing, and a polymer film forming.

The present application furthermore relates to a process comprising the steps:
a) if required, cleaning of the metal surface for removal of oils, greases and dirt,
b) if required, washing with water,
c) if required, pickling in order to remove rust or other oxides, in the presence or absence of the polymer (component A) used according to the invention,
d) if required, washing with water,
e) treatment of the metal surface in the presence of the polymer (component A) used according to the invention,
f) if required, washing with water,
g) if required, aftertreatment.

The treatment of the metal surface in step e) may be a passivation, in particular phosphation, by the process known to a person skilled in the art. A protective layer, a film or an impregnating material is applied to the metal. If a phosphation is carried out in step e), an aftertreatment of the metal surface in step g) with passivating additives is possible.

The washing with water is effected between the individual process steps, in order to avoid contamination of the solution required for the respective following step with components of the solution used in the preceding step. However, it is also conceivable to carry out the novel process as a no-rinse process, i.e. without the steps b, d) and f).

The steps comprising cleaning (step a)) and treatment of the metal surface in the presence of the polymer (component A) used according to the invention, preferably the passivation (step e)) can also be carried out in one step, i.e. using a formulation which also contains the novel composition in addition to the conventional cleaning agents.

After the process steps a) to g), the metal surface can be provided with a finish. Coating is likewise effected by methods known to a person skilled in the art.

A further embodiment of the present application relates to a process for the deposition of metals or metal alloys on a metal surface or plastics surface, the metal surface or plastics surface being brought into contact with the polymer (component A) comprising at least one structural unit of the formula (I) 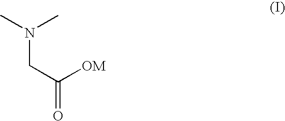
where this structural unit may be a part of the polymer main chain or may be bound to the polymer main chain via an anchor group, and
M is hydrogen or an ammonium or metal cation.

The metal surface or plastics surface is preferably brought into contact with a composition which contains the components A, B and, if required, C, and F, or with a composition which contains the components J and, if required, K as finisher components in addition to the components A, B and, if required, C, and F. Suitable components A, B, C, F, J and K have been mentioned above.

Deposition of metals or metal alloys on a plastics surface is carried out in general in a plastics metallization, in particular in the production of utility articles or circuit boards. Examples are copper-plating or nickel-plating of circuit boards or utility articles having a plastics surface without external current, it being possible for the copper-plating to be followed by nickel-plating and then chromium-plating and for nickel-plating to be followed by chromium-plating.

In a particularly preferred embodiment of the novel process, the deposition of metals or metal alloys on metal surfaces or plastics surfaces is effected in each case without an external current (i.e. chemically) or electrolytically. Such processes are known to a person skilled in the art. In the novel process, particular preference is given to chemical or electrochemical gold deposition, chemical or electrochemical copper deposition, chemical or electrochemical nickel deposition, chemical palladium deposition, electrochemical zinc deposition or electrochemical tin deposition. In addition to the deposition of said metals, said processes also include their alloys with other elements; CuZn, CuSn, CuNi, SnPb, SnAgBiCu, SnAgCu, SnBi, SnAg, SnCu, NiPd, NiP, ZnFe, ZnNi, ZnCo and ZnMn are particularly preferred, it being possible for said components of the alloy to be present in any desired concentration in the alloy. Processes in which conductive polymers are deposited are also according to the invention, said polymers being regarded as metals in the widest sense. Such a conductive polymer is polypyrrole.

Further embodiments of the novel process are, for example, cleaning, etching, polishing and pickling processes in which, in addition to the novel use of the component A, acids, oxidizing agents and corrosion inhibitors and dissolved metal salts may simultaneously be used, and processes for the production of circuit boards in which compositions comprising the component A can be used both in the metallization of the circuit board, including the holes contained therein, and for the surface treatment of the circuit board. Compositions comprising component A can be used on the one hand in the surface treatment of metals present on the circuit board, for example with the object of corrosion prevention or for improving the solderability, as well as in processes in which nonconductive surfaces are treated in the course of metal deposition with the compositions used according to the invention and comprising the component A, for example with the object of through-hole plating of circuit boards.

The present application furthermore relates to the use of polymers (component A) comprising at least one structural unit of the formula (I) 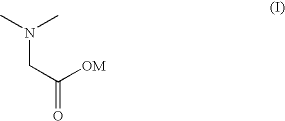
where this structural unit may be a part of the polymer main chain or may be bound to the polymer main chain via an anchor group, and
M is hydrogen or an ammonium or metal cation,
as complexing agents in the deposition of metals or metal alloys on metal surfaces or plastics surfaces or in the surface treatment of metals.

Preferably used polymers and suitable metal surfaces and suitable processes in which said polymers are to be used are mentioned above.

The examples which follow additionally illustrate the invention.

### EXAMPLES

### Example 1

### Chemical Copper Deposition

Circuit boards which were pretreated by industrially conventional methods (cleaning, etching, treatment with tin(II) chloride, palladium deposition, HBF₄ conditioning) are copper-plated in a mixture of 10 ml of a solution X, 10 ml of a solution Y and 80 ml of water. The composition of the solutions is as follows:

Solution X:

9 g of CuSO₄.5H₂O
27.5 g of formaldehyde (36.5% strength)
250 mg of fatty alcohol alkoxylate Plurafac® LF 600 from BASF AG water to 100 ml
   Solution Y:
18 g of NaOH
12 g of carboxymethylated polyethyleneimine sodium salt water to 100 ml

The carboxymethylated polyethyleneimine has an average molecular weight of 50 000 g/mol (determined by light scattering) and was prepared from polyethyleneimine analogously to example 1 in WO 97/40087, the degree of carboxymethylation being 80 mol %.

The mixture of solution X, solution Y and water has a higher stability than a comparative mixture which, instead of carboxymethylated polyethyleneimine, contains EDTA as a complexing agent. The stability was determined quantitatively on the basis of the amount of copper deposited when no substrate is immersed in the bath. Me more copper deposited in a bath without a substrate, the lower its stability. The amount of copper deposited under comparable conditions is at least 5% lower than in industrially conventional baths.

### Example 2

### Electrochemical Copper Deposition

For the electrochemical copper deposition on glass fiber-reinforced epoxy resin at 50° C. and a current density of 2 A/dm², an electroplating bath of the following composition is used:
18 g/l of copper, as copper sulfamate
250 g/l of sulfamic acid
15 g/i of citric acid
10 g/l of carboxymethylated polyethyleneimine sodium salt from example 1

### Example 3

### Chemical Nickel Deposition

For the chemical nickel deposition on glass fiber-reinforced epoxy resin at 90° C., a bath of the following composition is used:
21 g/l of nickel sulfate
24 g/l of sodium hypophosphite
28 g/l of lactic acid
22 g/l of propionic acid
5 g/l of carboxymethylated polyethyleneimine sodium salt from example 1
150 mg/l of thiourea

### Example 4

### Electrochemical Zinc Alloy Deposition

For the electrochemical deposition of an alloy layer comprising zinc and a fiber metal M on glass fiber-reinforced epoxy resin at 40° C. and a current density of 1.5 A/dm², electroplating baths of the following composition are used.
10 g/l of zinc, as zinc oxide
2 g/l of metal M, either Co, Fe, Ni or Mn, as sulfate
100 g/l of sodium hydroxide
15 g/l of carboxymethylated polyethyleneimine sodium salt from example 1
10 g/l of polyethyloneimine Lugalvan® G20 from BASF AG
1 g/l of pyridiniumpropylsulfobetaine

### Example 5

### Electrochemical Gold Deposition

For the electrochemical gold deposition on glass fiber-reinforced epoxy resin at 35° C. and a current density of 1 A/dm², an electroplating bath of the following composition is used:
8 g/l of gold, as potassium dicyanoaurate
250 mg/l of cobalt, as cobalt cyanide
100 g/l of carboxymethylated polyethyleneimine sodium salt from example 1

### Example 6

### Electrolytic Cleaning of Soft Steel

For the surface treatment of stainless steel, a bath of the following composition is used. The workpiece is connected therein as the cathode for 5 minutes at room temperature, at a current density of 1 A/dm².
100 g of carboxymethylated polyethyleneinine sodium salt from example 1
500 mg of alkylphenol ethocylate Lutensol® AP 10 from BASF AG water to 1000 ml

### Example 7

### Electrolytic Cleaning of Copper

For the surface treatment of copper, a bath of the following composition is used. The workpiece is connected therein as the cathode for 1 minute at room temperature, at a current density of 1 A/dm².
100 g of carboxymethylated polyethyleneimine sodium salt from example 1
7.5 g of potassium chloride
5 g of benzotriazole
500 mg of alkylphenol ethocylate Lutensol®AP 10 from BASF AG water to 1000 ml

1-12. (canceled)

13. A composition for the treatment of metal or plastics surfaces, comprising
a) at least one polymer as component A, comprising at least one structural unit of the formula (I) 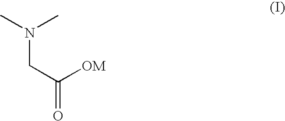
where this structural unit may be part of a polymer main chain or may be bound to a polymer main chain via an anchor group, and
M is hydrogen or a metal cation;
b) water or another solvent which is suitable for dissolving, dispersing, suspending or emulsifying the polymer (component A). as component B;
c) if required, surface-active compounds, dispersants, suspending media and/or emulsifiers as component C;
either
d) if required, a salt, an acid or a base based on transition metal cations, transition metal oxoanions, fluorometallates or lanthanoids as component D, and/or
e) at least one acid selected from the group consisting of phosphoric acid, sulfuric acid, sulfonic acid, nitric acid, hydrofluoric acid and hydrochloric acid as component B, or a base selected from the group consisting of alkali metal and alkaline earth metal hydroxides and ammonia solution
and/or
f) at least one metal oxide and/or metal salt as component F.

14. A composition as claimed in claim 13, wherein the weight average molecular weight of the polymer (component A) is greater than 500 g/mol.

15. A composition as claimed in claim 13, wherein the polymer (component A) contains one or more repeating units of the formulae (II), (III) and/or (IV), and/or one or two terminal groups of the formula (V), and, if required, further units of the formula (VI) 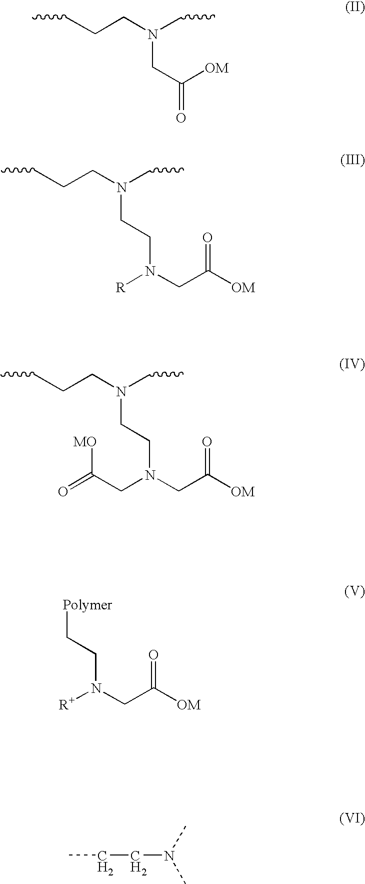
where
R is hydrogen or any desired substituted or unsubstituted organic radical
R* is hydrogen or —CH₂—CO₂M
M is hydrogen or an ammonium or metal cation
Polymer is any desired polymer which is suitable for binding the structural unit defined in formula (V).

16. A composition as claimed in claim 13 for the surface treatment of metals, comprising, in addition to the components A, B and, if required, C, and D and/or E,
g) at least one corrosion inhibitor as component G, and/or
h) compounds of Ce, Ni, Co, V, Fe, Zn, Zr, Ca, Mn, Mo, W, Cr and/or Bi as component H,
and/or
i) further assistants and additives as component I.

17. A composition as claimed in claim 13 for the deposition of metals or metal alloys on metal surfaces or plastics surfaces, comprising, in addition to the components A. B and, if required, C, and F,
j) if required, at least one acid or one alkali metal salt or alkaline metal earth salt of the corresponding acid as component I
and/or
k) if required, further additives as component K.

18. A process for the surface treatment of metals, wherein the metal surface is brought into contact with the composition as claimed in claim 13.

19. A process as claimed in claim 18, comprising the steps:
a) if required, cleaning of the metal surface for removal of oils, greases and dirt,
b) if required, washing with water,
c) if required, pickling In order to remove rust or other oxides, in the presence or absence of the polymer (component A) used according to the invention,
d) if required, washing with water,
e) treatment of the metal surface in the presence of a composition comprising
i) at least one polymer as component A, comprising at least one structural unit of the formula (I) 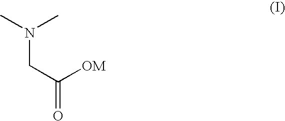
where this structural unit may be part of a polymer main chain or may be bound to a polymer main chain via an anchor group, and
M is hydrogen or a metal cation;
ii) water or another solvent which is suitable for dissolving, dispersing, suspending or emulsifying the polymer (component A). as component B;
iii) if required, surface-active compounds, dispersants, suspending media and/or emulsifiers as component C;
either
iv) if required, a salt, an acid or a base based on transition metal cations, transition metal oxoanions, fluorometallates or lanthanoids as component D, and/or
v) at least one acid selected from the group consisting of phosphoric acid, sulfuric acid, sulfonic acid, nitric acid, hydrofluoric acid and hydrochloric acid as component B, or a base selected from the group consisting of alkali metal and alkaline earth metal hydroxides and ammonia solution and/or
vi) at least one metal oxide and/or metal salt as component F,
f) if required, washing with water,
g) if required, aftertreatment.

20. A process for depositing metals or metal alloys on a metal surface or plastics surface, wherein the metal surface or plastics surface is brought into contact with a polymer (component A), comprising at least one structural unit of the formula (I) 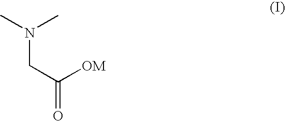
where this structural unit may be a part of the polymer main chain or may be bound to the polymer main chain by an anchor group, and
M is hydrogen or an ammonium or metal cation.

21. A process as claimed in claim 20, wherein the plastics surface is brought into contact with a composition comprising
a) at least one polymer as component A, comprising at least one structural unit of the formula (I) 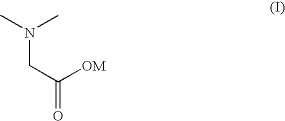
where this structural unit may be part of a polymer main chain or may be bound to a polymer main chain via an anchor group, and
M is hydrogen or a metal cation;
b) water or another solvent which is suitable for dissolving, dispersing, suspending or emulsifying the polymer (component A). as component B;
c) if required, surface-active compounds, dispersants, suspending media and/or emulsifiers as component C;
either
d) if required, a salt, an acid or a base based on transition metal cations, transition metal oxoanions, fluorometallates or lanthanoids as component D, and/or
e) at least one acid selected from the group consisting of phosphoric acid, sulfuric acid, sulfonic acid, nitric acid, hydrofluoric acid and hydrochloric
acid as component B, or a base selected from the group consisting of alkali metal and alkaline earth metal hydroxides and ammonia solution
and/or
f) at least one metal oxide and/or metal salt as component F.

22. A process as claimed in claim 20, wherein a chemical or electrochemical metal deposition is carried out.

23. A method of prevention of the corrosion of metal surfaces, comprising the step of treating the metal surfaces with the composition as claimed in claim 13.

24. A method of deposition of metals or metal alloys on metal surfaces or plastics surfaces, comprising the step of using a polymer comprising at least one structural unit of the formula (I) 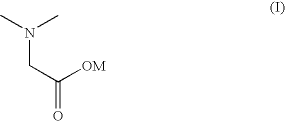
where this structural unit may be a part of the polymer main chain or may be bound to a polymer main chain via an anchor group, and
M is hydrogen or an ammonium or metal cation.
as a complexing agent.
